(19) United States
(12) Patent Application Publication
(10) Pub. No.: US 2008/0074797 A1
(43) Pub. Date: Mar. 27, 2008

(54) Storage medium drive capable of reducing wiring related to head slider

(75) Inventors: Yoshiaki Ikai, Kawasaki (JP); Toru Yokohata, Kawasaki (JP); Takahiro Imamura, Kawasaki (JP); Kenrou Yamamoto, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/878,533

(22) Filed: Jul. 25, 2007

(30) Foreign Application Priority Data
Sep. 27, 2006 (JP) 2006-262072

(51) Int. Cl. G11B 5/56; G11B 21/24

(52) U.S. Cl. 360/294.4

(57) ABSTRACT

A first wiring connects a first actuator to a controlling circuit on a head slider. The second wiring connects the second actuator to the first wiring in parallel with the first actuator. A first rectifying element is inserted in the first wiring. A second rectifying element is inserted in the second wiring. When electric voltage is applied to the first and second wiring in a first direction, the electric voltage acts on the first wiring. Only the first actuator is allowed to receive the electric voltage. When electric voltage is applied to the first and second wiring in a second direction opposite to the first direction, the electric voltage acts on the second wiring. Only the second actuator is allowed to receive the electric voltage in the second direction.

### BACKGROUND OF THE INVENTION

1. Field of the Invention

The present invention relates to a storage medium drive such as a hard disk drive, HDD. In particular, the present invention relates to a storage medium drive including a head slider, a head element mounted on the head slider, and actuators exhibiting a driving force enabling movement of the head element.

2. Description of the Prior Art

A hard disk drive, HDD, including actuators related to a head slider is well known as disclosed in Japanese Patent Application Publication No. 2004-022087, for example. The individual actuators serve to keep a head element following a target recording track, for example. In addition, a hard disk drive, HDD, utilizing thermal expansion of a non-magnetic layer so as to protrude a head element toward a recording medium is also well known as disclosed in Japanese Patent Application Publication No. 05-020635, for example.

An increased number of actuators related to a head slider leads to increase of wirings and terminals related to the head slider. Space, however, is limited in the individual head slider and a head suspension supporting the head slider. The wirings and terminals must be disposed within the limited space.

### SUMMARY OF THE INVENTION

It is accordingly an object of the present invention to provide a storage medium drive capable of reducing wirings and terminals in connection with a head slider.

According to a first aspect of the present invention, there is provided a storage medium drive comprising: a head slider; a head element mounted on the head slider; first and second actuators exhibiting a driving force to move the head element; a controlling circuit designed to output an electric signal; a first wiring connecting the first actuator to the controlling circuit; a second wiring connected to the first wiring at first and second diverging points, the second wiring connecting the second actuator to the first wiring in parallel with the first actuator; a first rectifying element inserted in the first wiring at a position between the first and second diverging points to rectify electric current in a first direction; and a second rectifying element inserted in the second wiring to rectify electric current in a second direction opposite to the first direction.

When electric voltage is applied to the first wiring in the first direction, the electric voltage acts on the first wiring between the first and second diverging points. The electric voltage is blocked at the second wiring. Only the first actuator is allowed to receive the electric voltage in the first direction. When electric voltage is applied to the first wiring in the second direction, the electric voltage acts on the second wiring between the first and second diverging points. The electric voltage is blocked at the first wiring between the first and second diverging points. Only the second actuator is allowed to receive the electric voltage in the second direction. The actions of the first and second actuators can respectively be controlled in this manner. A single voltage path can be employed outside the section between the first and second diverging points. This results in a reduction in the number of wirings between the controlling circuit and the first and second actuators.

A first electrically-conductive terminal may be inserted in the first wiring between the controlling circuit and the first diverging point. A second electrically-conductive terminal may likewise be inserted in the first wiring between the controlling circuit and the second diverging point. The first and second electrically-conductive terminals may be exposed on the head slider. A divergence of the wiring on the head slider leads to a reduction in the number of the electrically-conductive terminals on the head slider.

The controlling circuit may be designed to apply the alternating voltage to the first wiring. The alternating voltage enables supply of electric voltage alternately in the first and second directions. The actions of the first and second actuators can respectively be controlled in this manner.

Here, each of the first and second actuators may comprise: a non-magnetic layer located at a position adjacent to the head element, the non-magnetic layer having a predetermined thermal expansion coefficient; and a resistance element embedded in the non-magnetic layer for receiving electric current from the first or second wiring. The resistance element generates heat in response to supply of electric current to the resistance element. The generated heat causes expansion of the non-magnetic layer. The expansion leads to movement of the head element.

A specific head slider may be provided to realize the mentioned storage medium drive. The head slider may comprise: a slider body; a head element mounted on the slider body; first and second actuators mounted on the slider body, the first and second actuators respectively exhibiting a driving force to move the head element; first and second electrically-conductive terminals located on the slider body; a first wiring connecting the first actuator to the first and second electrically-conductive terminals; a first rectifying element inserted in the first wiring to rectify electric current, the electric current flowing from the first electrically-conductive terminal toward the second electrically-conductive terminal; a second wiring connecting the second actuator to the first and second electrically-conductive terminals; and a second rectifying element inserted in the second wiring to rectify electric current, the electric current flowing from the second electrically-conductive terminal toward the first electrically-conductive terminal, for example. A common electric voltage can be supplied to the first and second wirings from the first and second electrically-conductive terminals. The first and second rectifying elements enable individual supply of the electric voltage to the first and second wirings. The first and second actuators can respectively be controlled in this manner. Since the first and second electrically-conductive terminals are utilized in common for the application of the electric voltage to the first and second wirings, the number of wirings from the head slider can be reduced. Moreover, the number of the electrically-conductive terminals is reduced on the head slider.

According to a second aspect of the preset invention, there is provided a storage medium drive comprising: a head slider; a head element mounted on the head slider; first and second actuators exhibiting a driving force to move the head element; a controlling circuit designed to output an electric signal; a first wiring connecting the first actuator to the controlling circuit; a second wiring connected to the first wiring at first and second diverging points, the second wiring connecting the second actuator to the first wiring in parallel with the first actuator; a first filtering circuit established in the first wiring at a position between the first and second diverging points, the first filtering circuit allowing signals of a first frequency band to pass through; and a second filtering circuit established in the second wiring, the second filtering circuit allowing signals of a second frequency band different from the first frequency band to pass through.

When electric voltage is applied to the first wiring, signals of the first frequency band pass through the first wiring at a section between the first and second diverging points. The signals of the first frequency band are blocked at the second wiring. The first actuator is thus allowed to solely receive the signals of the first frequency band. Likewise, signals of the second frequency band pass through the second wiring at a section between the first and second diverging points. The signals of the second frequency band are blocked at the first wiring. The second actuator is thus allowed to solely receive the signals of the second frequency band. The actions of the first and second actuators can respectively be controlled in this manner. A common voltage path can be employed outside the section between the first and second diverging points. This results in a reduction in the number of wirings between the controlling circuit and the first and second actuators.

The controlling circuit may be designed to apply superposed signals including the signals of the first and second frequency bands to the first wiring. Only the signals of the first frequency band in the superposed signals are allowed to pass through the first filtering circuit. Only the signals of the second frequency band in the superposed signals are allowed to pass through the second filtering circuit. The actions of the first and second actuators can respectively be controlled in this manner.

The storage medium drive may further comprise a capacitor connected in series to the first actuator in the first wiring to establish the first filtering circuit in combination with the electric resistance of the first actuator. The first filtering circuit can be established in the first wiring in a relatively facilitated manner. The first actuator may comprise a non-magnetic layer located at a position adjacent to the head element, the non-magnetic layer having a predetermined thermal expansion coefficient; and a resistance element embedded in the non-magnetic layer for receiving electric current from the first wiring. The first actuator serves as electric resistance in this manner.

The storage medium drive may also comprise a resistance element connected in series to the second actuator in the second wiring to establish the second filtering circuit in combination with the capacitance of the second actuator. The second filtering circuit can be established in the second wiring in a relatively facilitated manner. The second actuator may comprise a piezoelectric element including a piezoelectric material interposed between electrodes. The second actuator serves as capacitance.

A specific head slider may be provided to realize the mentioned storage medium drive. The head slider may comprise: a slider body; a head element mounted on the slider body; first and second actuators mounted on the slider body, the first and second actuators exhibiting a driving force to move the head element; a pair of electrically-conductive terminals located on the slider body; a first wiring connecting the first actuator to the electrically-conductive terminals; a second wiring connected to the first wiring at first and second diverging points, the second wiring connecting the second actuator to the first wiring in parallel with the first actuator; a first filtering circuit established in the first wiring at a position between the first and second diverging points, the first filtering circuit allowing signals of a first frequency band to pass through; and a second filtering circuit established within the second wiring, the second filtering circuit allowing signals of a second frequency band different from the first frequency band to pass through, for example.

The storage medium drive may further comprise: a third wiring connected to the first wiring at the first and second diverging points, the third wiring connecting a third actuator to the first wiring in parallel with the first and second actuators; and a third filtering circuit established in the third wiring, the third filtering circuit allowing signals of a third frequency band different from the first and second frequency bands to pass through. The actions of the first to third actuators can respectively be controlled in this manner. The storage medium drive may further comprise: a first resistance element connected in series to the third actuator in the third wiring; a second resistance element disposed in the third wiring in parallel with the third actuator and the first resistance element; and a capacitor connected in series to the third actuator and the first and second resistance elements in the third wiring, the capacitor establishing the third filtering circuit in combination with the capacitance of the third actuator and the electric resistance of the first and second resistance elements. The third filtering circuit can be established in a relatively facilitated manner. The third actuator may comprise a piezoelectric element including a piezoelectric material interposed between electrodes.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive, HDD, according to a specific example of the present invention;

FIG. 2 is an enlarged perspective view of a flying head slider according to a first embodiment of the present invention;

FIG. 3 is an enlarged front view of an electromagnetic transducer observed on a medium-opposed surface or air bearing surface;

FIG. 4 is a sectional view taken along the line 4-4 in FIG. 3;

FIG. 5 is a partial sectional view schematically illustrating protrusion of first and second actuators;

FIG. 6 is an enlarged perspective view schematically illustrating the outflow end surface of the flying head slider or surface of a head protection film;

FIG. 7 is a block diagram schematically showing the control system of the first and second actuators;

FIG. 8 is a graph showing the gain characteristic and the phase characteristic of the first and second actuators;

FIGS. 9A to 9E are graphs schematically showing the mechanism for controlling the first and second actuators;

FIG. 10 is a graph showing the movement amount of the first actuator;

FIG. 11 is a graph showing the movement amount of the second actuator;

FIGS. 12A to 12E are graphs schematically showing the mechanism for controlling the first and second actuators based on a DC (direct current) offset;

FIG. 13 is a waveform chart schematically showing a rectangular waveform according to another specific example;

FIG. 14 is a block diagram schematically showing a circuit designed to generate the rectangular waveform;

FIG. 15 is a vertical sectional view schematically illustrating a method of making a diode;

FIG. 16 is a vertical sectional view schematically illustrating the method of making a diode;

FIG. 17 is a vertical sectional view schematically illustrating the method of making a diode;

FIG. 18 is a vertical sectional view schematically illustrating the method of making a diode;

FIG. 19 is a vertical sectional view schematically illustrating the method of making a diode;

FIG. 20 is a vertical sectional view schematically illustrating the method of making a diode;

FIG. 21 is a vertical sectional view schematically illustrating the method of making a diode;

FIG. 22 is a vertical sectional view schematically illustrating the method of making a diode;

FIG. 23 is an enlarged perspective view of a flying head slider according to a second embodiment of the present invention;

FIG. 24 is an enlarged perspective view schematically illustrating the outflow end surface of the flying head slider or surface of a head protection film;

FIG. 25 is a block diagram schematically showing the control system of first and second actuators;

FIG. 26 is a graph showing the gain characteristic and the phase characteristic of the first actuator;

FIG. 27 is a graph showing the gain characteristic and the phase characteristic of the second actuator or piezoelectric actuator;

FIG. 28 is a graph showing the gain characteristic and the phase characteristic of a first filtering circuit;

FIG. 29 is a graph showing the gain characteristic and the phase characteristic of a second filtering circuit;

FIGS. 30A to 30D are graphs schematically showing the mechanism for controlling the first and second actuators;

FIG. 31 is a graph showing the movement amount of the first actuator;

FIG. 32 is a graph showing the movement amount of the second actuator;

FIG. 33 is an enlarged perspective view of a flying head slider according to a third embodiment of the present invention;

FIG. 34 is an enlarged perspective view schematically illustrating the outflow end surface of the flying head slider or surface of a head protection film;

FIG. 35 is a block diagram schematically showing the control system of first, second and third actuators;

FIG. 36 is a graph showing the gain characteristic and the phase characteristic of the first actuator;

FIG. 37 is a graph showing the gain characteristic and the phase characteristic of the second actuator;

FIG. 38 is a graph showing the gain characteristic and the phase characteristic of the third actuator;

FIG. 39 is a graph showing the gain characteristic and the phase characteristic of a first filtering circuit;

FIG. 40 is a graph showing the gain characteristic and the phase characteristic of a second filtering circuit;

FIG. 41 is a graph showing the gain characteristic and the phase characteristic of a third filtering circuit;

FIGS. 42A to 42E are graphs schematically showing the mechanism for controlling the first and second actuators;

FIG. 43 is a graph showing the movement amount of the first actuator;

FIG. 44 is a graph showing the movement amount of the second actuator;

FIG. 45 is a graph showing the movement amount of the third actuator;

FIG. 46 is a vertical sectional view schematically illustrating a method of making a capacitor;

FIG. 47 is a vertical sectional view schematically illustrating the method of making a capacitor; and

FIG. 48 is a vertical sectional view schematically illustrating the method of making a capacitor.

### DESCRIPTION OF THE PREFERRED EMBODIMENTS

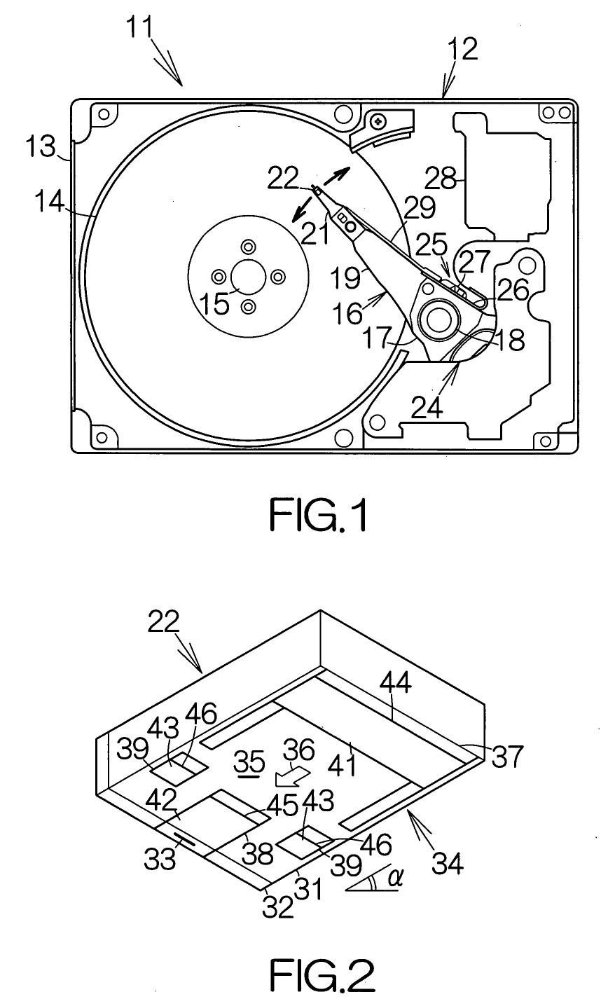

FIG. 1 schematically illustrates the inner structure of a hard disk drive, HDD, 11 as an example of a storage medium drive or a storage device according to the present invention. The hard disk drive 11 includes an enclosure 12 including a box-shaped base 13 and an enclosure cover, not shown. The base 13 defines an inner space in the form of a flat parallelepiped, for example. The base 13 may be made of a metallic material such as aluminum, for example. Molding process may be employed to form the base 13. The enclosure cover is coupled to the base 13 to close the opening of the base 13. An airtight inner space is defined between the base 13 and the enclosure cover. Pressing process may be employed to form the enclosure cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head suspension 21 is attached to the front or tip end of the individual carriage arm 19. The head suspension 21 is designed to extend forward from the carriage arm 19. A flexure, not shown, is attached to the tip end of the head suspension 21. A so-called gimbal spring is defined in the flexure. A flying head slider 22 is fixed to the surface of the gimbal spring. The gimbal spring allows the flying head slider 22 to change its attitude relative to the head suspension 21. The aftermentioned magnetic head or electromagnetic transducer is mounted on the flying head slider 22.

When the magnetic recording disk 14 rotates, the flying head slider 22 is allowed to receive an airflow generated along the rotating magnetic recording disk 14. The airflow serves to generate a positive pressure or a lift as well as a negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the carriage 16 swings around the vertical support shaft 18 during the flight of the flying head slider 22, the flying head slider 22 is allowed to move along the radial direction of the magnetic recording disk 14. The magnetic head on the flying head slider 22 is thus allowed to cross the data zone defined between the innermost and outermost recording tracks. The magnetic head on the flying head slider 22 is positioned right above a target recording track on the magnetic recording disk 14.

A power source or voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspensions 21 to swing.

As is apparent from FIG. 1, a flexible printed circuit board unit 25 is located on the carriage block 17. The flexible printed circuit board unit 25 includes a head IC (integrated circuit) 27 mounted on a flexible printed wiring board 26. The head IC 27 is designed to supply the read element of the magnetic head with a sensing current when the magnetic bit data is to be read. The head IC 27 is also designed to supply the write element of the magnetic head with a writing current when the magnetic bit data is to be written. A small-sized circuit board 28 is located within the inner space of the enclosure 12. A printed circuit board, not shown, is attached to the back surface of the bottom plate of the base 13. The small-sized circuit board 28 and the printed circuit board are designed to supply the head IC 27 with the sensing current and the writing current.

A flexible printed wiring board 29 is utilized to supply the sensing current and writing current. The flexible printed wiring board 29 is related to the individual flexure. The flexible printed wiring board 29 includes a metallic thin film made of stainless steel or the like, an insulating layer, an electrically-conductive layer and a protection layer. The insulating layer, the electrically-conductive layer and the protection layer are overlaid on the metallic thin film in this sequence. The electrically-conductive layer includes a wiring pattern, not shown, extending along the flexible printed wiring board 29. The electrically-conductive layer may be made of an electrically-conductive material such as copper. The insulating layer and the protection layer may be made of a resin material such as polyimide resin.

The wiring pattern on the flexible printed wiring board 29 is connected to the flying head slider 22. The flexible printed wiring board 29 extends backward along the side of the carriage arm 19 from the head suspension 21. The other end of the flexible printed wiring board 29 is connected to the flexible printed circuit board unit 25. The wiring pattern on the flexible printed wiring board 29 is connected to a wiring pattern, not shown, on the flexible printed circuit board unit 25. Electrical connection is in this manner established between the flying head slider 22 and the flexible printed circuit board unit 25.

FIG. 2 illustrates a specific example of the flying head slider 22 according to a first embodiment of the present invention. The flying head slider 22 includes a slider body 31 in the form of a flat parallelepiped, for example. A head protection film 32 is overlaid on the outflow or trailing end of the slider body 31. The aforementioned magnetic head, namely an electromagnetic transducer 33, is incorporated in the head protection film 32. The electromagnetic transducer 33 will be described later in detail.

The slider body 31 may be made of a hard material such as Al₂O₃—TiC. The head protection film 32 may be made of a relatively soft material such as Al₂O₃ (alumina). A medium-opposed surface or bottom surface 34 is defined over the slider body 31 so as to face the magnetic recording disk 14 at a distance. A flat base surface 35 as a reference surface is defined on the bottom surface 34. When the magnetic recording disk 14 rotates, airflow 36 acts on the bottom surface 34 in the direction from the front end toward the rear end of the slider body 31.

A front rail 37 is formed on the bottom surface 34. The front rail 37 stands upright from the base surface 35 near the inflow end of the base surface 35. The front rail 37 extends along the inflow end of the base surface 35 in the lateral direction of the slider. A rear rail 38 is likewise formed on the bottom surface 34. The rear rail 38 stands upright from the base surface 35 near the outflow end of the base surface 35. The rear rail 38 is located on the middle position in the lateral direction.

A pair of auxiliary rear rails 39, 39 is likewise formed on the bottom surface 34. The auxiliary rear rails 39, 39 stand upright from the base surface 35 near the outflow end of the base surface 35. The auxiliary rear rails 39, 39 are respectively located along the side edges of the base surface 35. The auxiliary rear rails 39, 39 are thus spaced from each other in the lateral direction. The rear rail 38 is located between the auxiliary rear rails 39, 39.

So-called air bearing surfaces 41, 42, 43, 43 are defined on the top surfaces of the front rail 37, the rear rail 38 and the auxiliary rear rails 39, 39. Steps 44, 45, 46, 46 are defined to respectively connect the inflow ends of the air bearing surfaces 41, 42, 43, 43 to the top surfaces of the rails 37, 38, 39, 39. The bottom surface 34 receives the airflow 36 generated along the rotating magnetic recording disk 14. The individual step 44, 45, 46 serves to cause a relatively large positive pressure or lift on the corresponding air bearing surface 41, 42, 43. A relatively large negative pressure is generated behind the front rail 37. The flying attitude of the flying head slider 22 is thus established based on the balance between the lift and the negative pressure.

A protection film, not shown, is formed on the surface of the slider body 31 at each of the air bearing surfaces 41, 42, 43, for example. The aforementioned electromagnetic transducer 33 is designed to expose a read gap and a write gap at the surface of the protection film 32 at a position downstream of the air bearing surface 42. The protection film covers over the read gap and the write gap. The protection film may be made of diamond-like-carbon (DLC), for example. It should be noted that the flying head slider 22 can take any shape or form different from the described one.

FIG. 3 illustrates the electromagnetic transducer 33 in detail. The electromagnetic transducer 33 includes a CPP (Current-Perpendicular-to-the-Plane) structure read head element 47 and a write head element 48, for example. The read head element 47 is designed to detect variation in the electric resistance in response to a magnetic field applied from the magnetic recording disk 14 in a conventional manner. The detected variation is utilized to discriminate magnetic bit data on the magnetic recording disk 14. The write head is designed to utilize a magnetic field induced at an electrically-conductive coil pattern, not shown, for example, in a conventional manner. The induced magnetic field is utilized to write magnetic bit data onto the magnetic recording disk 14. The read head element 47 and the write head element 48 are interposed between an Al₂O₃ layer 49 and an Al₂O₃ layer 51. The Al₂O₃ layer 49 corresponds to the upper half layer of the aforementioned head protection film 32, namely an overcoat film. The Al₂O₃ layer 51 corresponds to the lower half layer of the head protection film 32, namely an undercoat film.

The read head element 47 includes a magnetoresistive film 52 such as a spin valve film or a tunnel-junction film. The magnetoresistive film 52 is interposed between an upper electrode 53 and a lower electrode 54. The upper and lower electrodes 53, 54 are designed to expose their front ends at the surface of the head protection film 32. The front ends of the upper and lower electrodes 53, 54 respectively contact with the upper and lower boundaries of the magnetoresistive film 52. The upper and lower electrodes 53, 54 are utilized to supply the sensing current to the magnetoresistive film 52. The upper and lower electrodes 53, 54 may have not only electrical conductivity but also soft magnetism. When each of the upper and lower electrodes 53, 54 is made of a soft magnetic material having electrical conductivity, such as permalloy (NiFe alloy), the upper and lower electrodes 53, 54 can also respectively serve as upper and lower shielding layers of the read head element 47.

The write head element 48 includes an upper magnetic pole layer 56 and a lower magnetic pole layer 57. The upper magnetic pole layer 56 defines the front end exposed at the surface of the head protection film 32. The front end of the upper magnetic pole layer 56 is opposed to the magnetic recording disk 14. The lower magnetic pole layer 57 likewise defines the front end exposed at the surface of the head protection film 32. The front end of the lower magnetic pole layer 57 is opposed to the magnetic recording disk 14. The upper and lower magnetic pole layers 56, 57 may be made of FeN, NiFe, or the like. The upper and lower magnetic pole layers 56, 57 in combination establish a magnetic core of the write head element 48.

A non-magnetic gap layer 58 is interposed between the upper and lower magnetic pole layers 56, 57. The non-magnetic gap layer 58 is made of Al₂O₃, for example. When magnetic field is generated in the aftermentioned thin film coil pattern, magnetic flux is exchanged between the upper and lower magnetic pole layers 56, 57. The non-magnetic gap layer 58 serves to force the magnetic flux to leak from surface of the head protection film 32 toward the magnetic recording disk 14. The leaked magnetic flux forms a magnetic field for recordation.

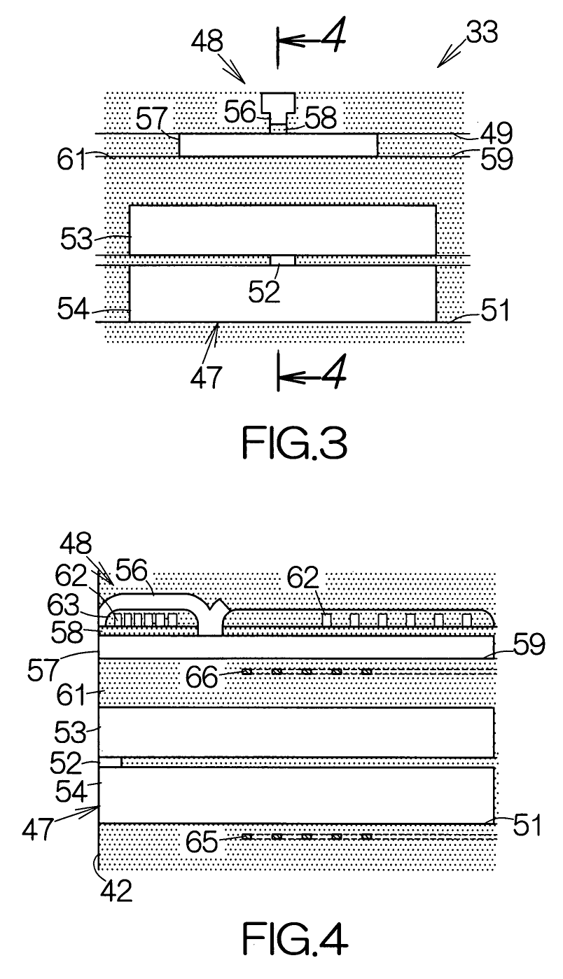

Referring also to FIG. 4, the lower magnetic pole layer 57 extends along a reference plane 59 above the upper electrode 53. The reference plane 59 is defined on the surface of a non-magnetic layer 61 made of Al₂O₃. The non-magnetic layer 61 may be overlaid on the upper electrode 53 by a constant thickness. The non-magnetic layer 61 serves to establish magnetic isolation between the upper electrode 53 and the lower magnetic pole layer 57.

The non-magnetic gap layer 58 extends on the lower magnetic pole layer 57 by a constant thickness. The thin film coil pattern 62 is located on the non-magnetic gap layer 58. The thin film coil pattern 62 swirls along a plane. The thin film coil pattern 62 is embedded within an insulating layer 63 on the non-magnetic gap layer 58. The aforementioned upper magnetic pole layer 56 is formed on the surface of the insulating layer 63. The upper magnetic pole layer 56 is magnetically connected to the lower magnetic pole layer 57 at the center of the thin film coil pattern 62. Magnetic flux runs through the upper and lower magnetic pole layers 56, 57 in response to supply of electric current to the thin film coil pattern 62.

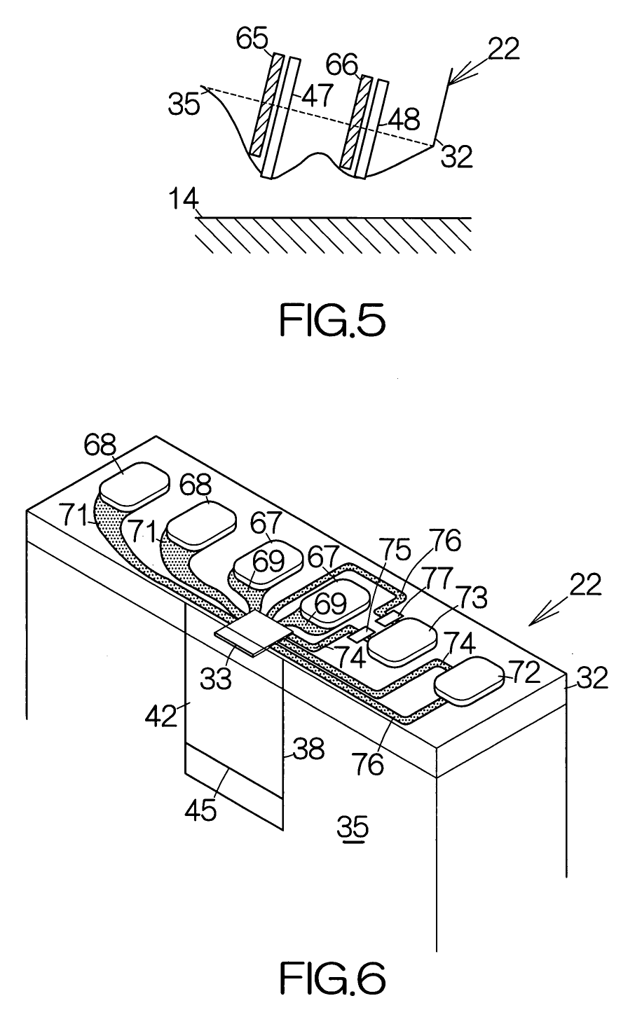

A first heating wiring pattern 65 is embedded in the Al₂O₃ film 51 at a position adjacent to the read head element 47. A second heating wiring pattern 66 is likewise embedded in the non-magnetic layer 61 at a position adjacent to the write head element 48. The first and second heating wiring patterns 65, 66 may extend along an imaginary plane set parallel to the reference surface 59, for example. The first and second heating wiring patterns 65, 66 serve as a resistance element according to the present invention. Since the Al₂O₃ film 51 and the non-magnetic layer 61 have a relatively large thermal expansion coefficient, the Al₂O₃ film 51 and the non-magnetic layer 61 efficiently expand in response to supply of electric current to the first and second heating wiring patterns 65, 66. The Al₂O₃ film 51 and the non-magnetic layer 61 thus protrude from the base surface 35, as shown in FIG. 5. The read head element 47 and the write head element 48 thus get closer to the magnetic recording disk 14. The protrusion amount of the read head element 47 determines the flying height of the read head element 47. The protrusion amount of the write head element 48 likewise determines the flying height of the write head element 48. In this case, the first heating wiring pattern 65 and the Al₂O₃ film 51 in combination establish a first actuator. The second heating wiring pattern 66 and the non-magnetic film 61 in combination establish a second actuator.

As shown in FIG. 6, two pairs of electrically-conductive signal line terminals 67, 67 and 68, 68 are located on the head protection film 32. The electrically-conductive signal line terminals 67, 67 in a pair is respectively connected to the aforementioned upper and lower electrode terminals 53, 54. A predetermined wiring pattern 69 is utilized to establish the connection. The electrically-conductive signal line terminals 68, 68 in another pair is connected to the aforementioned thin film coil pattern 62. A predetermined wiring pattern 71 may be utilized to establish the connection. The electrically-conductive signal line terminals 67, 68 are exposed at the surface of the head protection film 32.

The electrically-conductive signal line terminals 67 are connected to the wiring pattern on the flexible printed wiring board 29. A connecting terminal such as a metallic ball made of Au is utilized to establish the connection, for example. The magnetoresistive film 52 is in this manner supplied with the sensing current from the head IC 27. The electrically-conductive signal line terminals 68 are likewise connected to the wiring pattern on the flexible printed wiring board 29. A connecting terminal such as a metallic ball made of Au is utilized to establish the connection, for example. The thin film coil pattern 62 is in this manner supplied with the writing current from the head IC 27.

Additionally, first and second electrically-conductive terminals 72, 73 are located on the head protection film 32. The first electrically-conductive terminal 72 is connected to the second electrically-conductive terminal 73. A first wiring pattern 74 is utilized to establish the connection. The aforementioned first heating wiring pattern 65 is defined in the first wiring pattern 74. A first rectifying element or first diode 75 is located in the first wiring pattern 74. The second electrically-conductive terminal 73 is likewise connected to the first electrically-conductive terminal 72. A second wiring pattern 76 is utilized to establish the connection. The second wiring pattern 76 extends in parallel with the first wiring pattern 74. The aforementioned second heating wiring pattern 66 is defined in the second wiring pattern 76. A second rectifying element or second diode 77 is located in the second wiring pattern 76. The first and second electrically-conductive terminals 72, 73 are exposed on the surface of the head protection film 32.

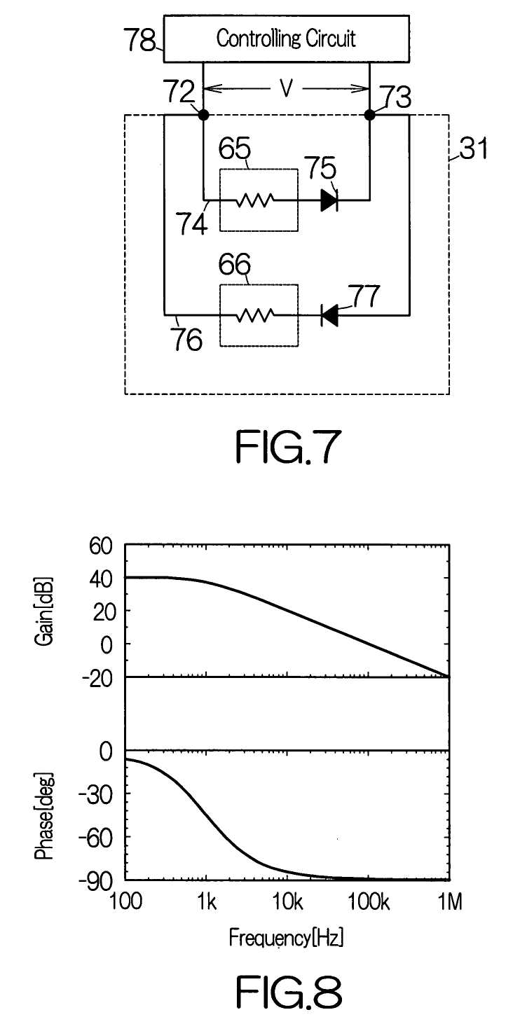

The first and second electrically-conductive terminals 72, 73 are connected to the wiring pattern on the flexible printed wiring board 29. A connecting terminal such as a metallic ball made of Au is utilized to establish the connection. As shown in FIG. 7, a controlling circuit 78 is connected to the first and second electrically-conductive terminals 72, 73. In this case, the wiring pattern on the flexible printed wiring board 29 in combination with the first wiring pattern 74 establish a first wiring of the present invention. The first and second electrically-conductive terminals 72, 73 respectively serve as first and second diverging points of the present invention. The first diode 75 serves to allow electric current to run from the first electrically-conductive terminal 72 toward the second electrically-conductive terminal 73. The second diode 77 serves to allow electric current to run from the second electrically-conductive terminal 73 toward the first electrically-conductive terminal 72. The controlling circuit 78 may be mounted on the small-sized circuit board 28, for example.

Now, assume that the alternating voltage is applied to the wiring pattern on the flexible printed wiring board 29 from the controlling circuit 78. The driving characteristic of the first and second actuators is specified by the following transfer function:

$$\begin{matrix}\text{[Expression 1]} & \\ \frac{Z ( s )}{W ( s )} = \frac{α}{\frac{τ}{2 π} s + 1} & ( 1 )\end{matrix}$$

In this case, Z denotes the movement amount [nm] of the actuator. W denotes the power consumption [W] of the actuator. α denotes the gain [nm/W]. τ denotes the time constant [s]. If the gain α is set at 100[nm/W] and the time constant τ is set at 1.0[ms], for example, the gain and phase characteristics of the actuator are established as shown in FIG. 8.

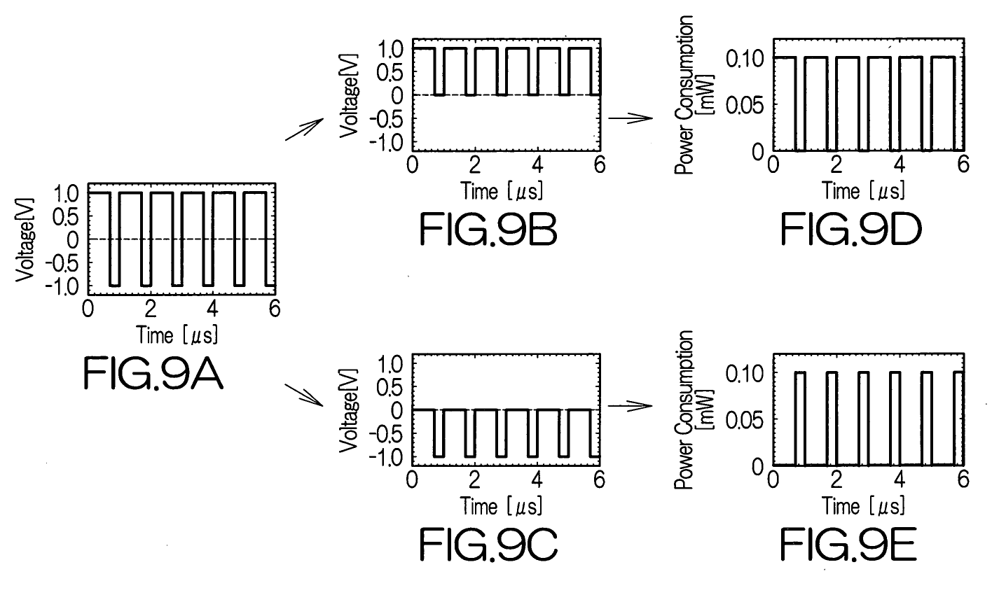

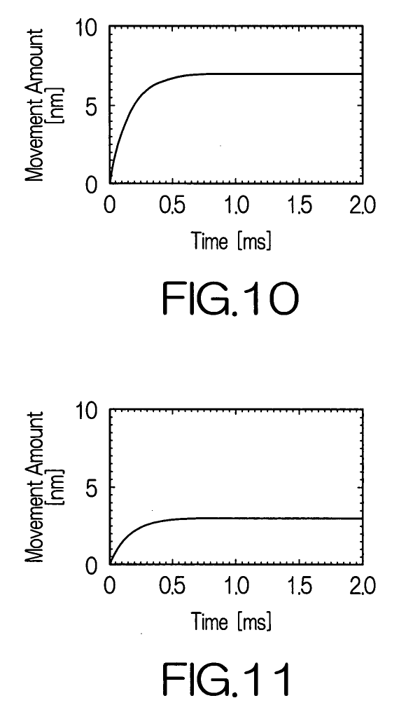

As shown in FIG. 9A, the alternating voltage has the waveform of a rectangular wave, for example. The amplitude of the voltage is set at ±1.0 [V]. The frequency is set at 1.0 [MHz]. The duty ratio is set at 7:3 between the positive voltage and the negative voltage, for example. In this case, the first diode 75 allows application of the positive voltage to the first heating wiring pattern 65. The first diode 75 serves to block application of the negative voltage to the first heating wiring pattern 65. The positive voltage is thus solely applied to the first heating wiring pattern 65, as shown in FIG. 9B. The second diode 77 allows application of the negative voltage to the second heating wiring pattern 66. The second diode 77 serves to block application of the positive voltage to the second heating wiring pattern 66. The negative voltage is thus solely applied to the second heating wiring pattern 66, as shown in FIG. 9C. The positive voltage thus controls the operation of the first actuator. The negative voltage likewise controls the operation of the second actuator. If the electric resistance of the first and second actuators is set at 10 [Ω], respectively, the amounts of the power consumption of the first and second actuators are respectively specified as shown in FIGS. 9D and 9E. The movement amounts of the first and second actuators are thus respectively specified as shown in FIGS. 10 and 11. The movement amounts of the first and second actuators reflect the duty ratio of 7:3. As is apparent from FIG. 5, the read head element 47 protrudes by a relatively larger amount in the flying head slider 22 during the flight. The write head element 48 protrudes by a relatively small amount. Both the read head element 47 and the write head element 48 are allowed to get closest to the magnetic recording disk 14. The first and second actuators can separately be controlled in this manner.

Only two pairs of wirings need to be formed on the flying head slider 22 to operate the first and second actuators in the hard disk drive 11. Only one pair of wirings needs to be established in common for the first and second actuators between the controlling circuit 78 and the flying head slider 22. The number of wirings is thus reduced. All the wirings can sufficiently be disposed even within a limited space on the flexible printed wiring board 29. In addition, only one pair of electrically-conductive terminals needs to be formed on the flying head slider 22 to operate the first and second actuators. The number of electrically-conductive terminals is thus reduced as compared with the case where the electrically-conductive terminals are separately arranged for each of the first and second actuators. All the electrically-conductive terminals can sufficiently be arranged even within a limited space on the flying head slider 22.

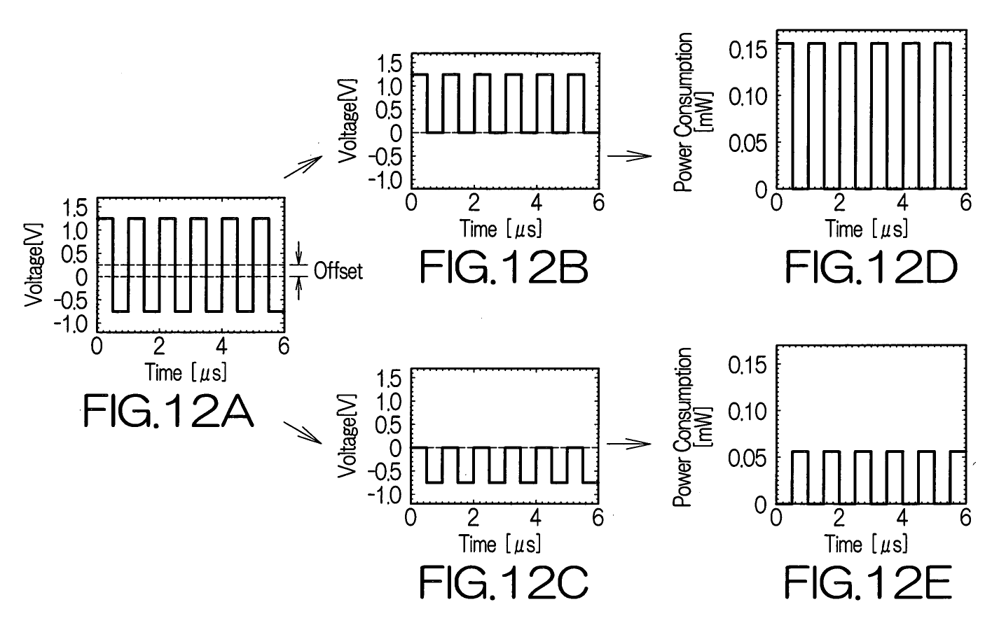

The protrusion amounts of the read head element 47 and the write head element 48 may respectively be controlled in the flying head slider 22 through adjustment of a so-called DC (direct current) offset, as shown in FIGS. 12A-12E, for example. The alternating voltage may be superposed on the direct voltage corresponding to an offset in the controlling circuit 78. In this case, the duty ratio may be set at 1:1 or at a certain ratio.

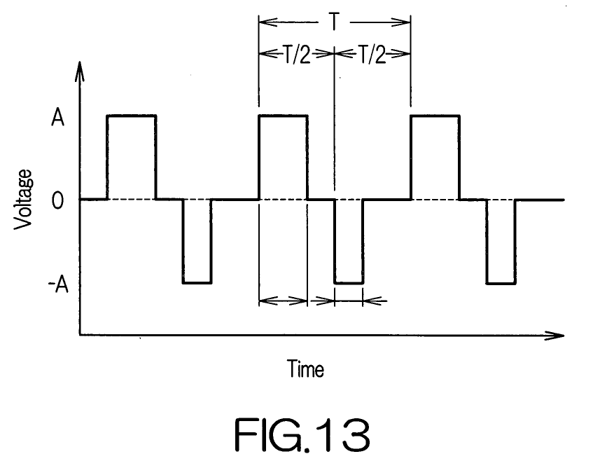

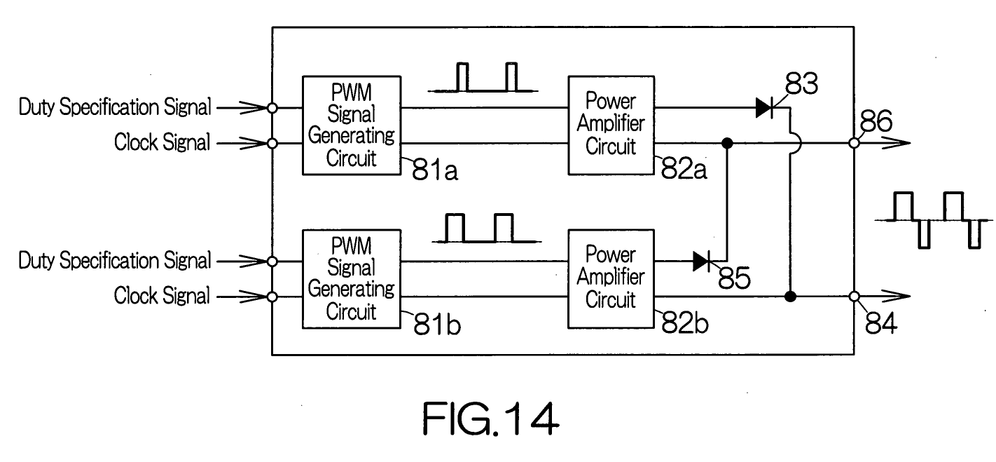

The controlling circuit 78 may adjust the duration of output of the alternating voltage within a constant period T/2 as shown in FIG. 13, for example. The amplitude of the applied voltage may be kept constant. A PWM (pulse-width modulation) signal generating circuits 81a, 81b may be utilized to generate such a rectangular wave as shown in FIG. 14, for example. Duty specification signals and predetermined clock signals are supplied to each of the PWM signal generating circuits 81a, 81b. The duty specification signals are utilized to specify the pulse width. The PWM signal generating circuits 81a, 81b are designed to output pulse signals having the designated pulse width. The pulse signals are amplified in power amplifier circuits 82a, 82b. The pulse signals of the PWM signal generating circuit 81a are output to an output terminal 84 through a diode 83. The pulse signals of the PWM signal generating circuit 81b are likewise output to an output terminal 86 through a diode 85. The duration of output of the voltage is in this manner adjusted within a constant period T/2.

The controlling circuit 78 is expected to output the alternating voltage at a high frequency having a period sufficiently shorter than the time constant of the first and second actuators in the hard disk drive 11. The alternating voltage of such a high frequency serves to prevent the first and second actuators from moving in accordance with the waveform of the alternating voltage. In the case where the alternating voltage of a low frequency is applied to the first and second actuators, the movement of the first and second actuators reflects the waveform of the alternating voltage. Specifically, the first and second actuators vibrate to follow the waveform.

A brief description will be made on a method of making the diodes 75, 77. As shown in FIG. 15, a n-type Si film 87 is first prepared. The n-type Si film 87 may be formed on a substrate, for example. A small amount of phosphorus (P) is added to a Si crystal to form the n-type Si film 87, for example. An oxidized film 88 is formed on the surface of the n-type Si film 87. A so-called thermal oxidation method is employed to form the oxidized film 88. Photoresist 89 is subsequently applied to the surface of the oxidized film (SiO₂ film) 88.

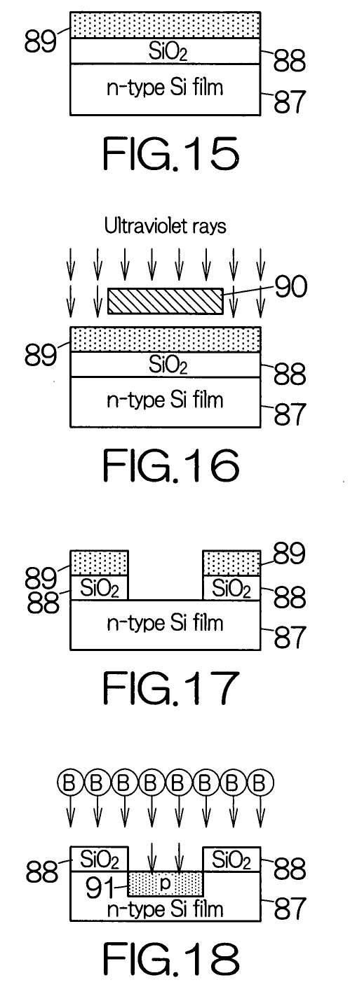

As shown in FIG. 16, the photoresist 89 is then subjected to exposure. Ultraviolet rays are utilized to irradiate the photoresist 89. A photomask 91 is utilized to block the irradiation of the ultraviolet rays on a specific section. The photoresist 89 is partly exposed to the ultraviolet rays in this manner.

The unexposed section of the photoresist 89 is then removed as shown in FIG. 17. A predetermined developing solution is utilized for the removal. The exposed section of the photoresist 89 remains on the oxidized film 88. The oxidized film 88 is then subjected to application of an etching solution. A hydrofluoric acid solution is employed as the etching solution, for example. This results in removal of a portion of the oxidized film 88 around the photoresist 89. The n-type Si film 87 gets exposed in a void defined in the photoresist 89.

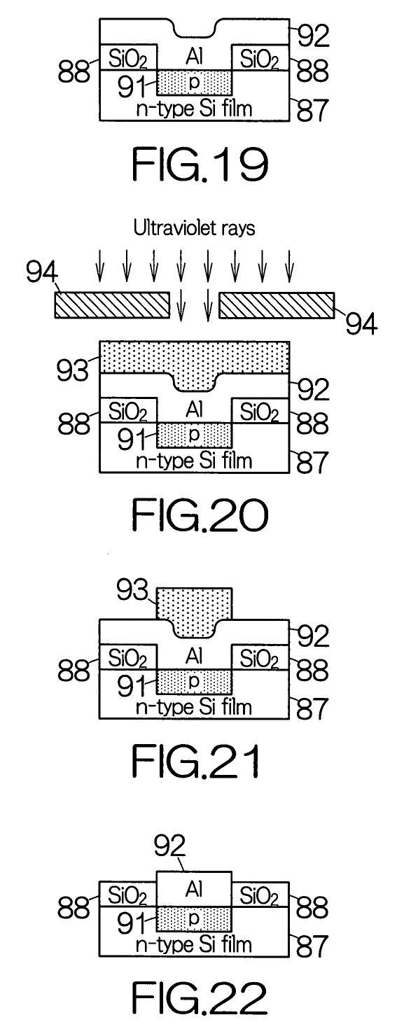

As shown in FIG. 18, thermal diffusion of boron (B) is then effected on the n-type Si film 87. The n-type Si film 87 is transformed into a p-type semiconductor 91 in response to the thermal diffusion. This results in establishment of p-n junction. Aluminum 92 is then deposited on the entire surface as shown in FIG. 19. Sputtering is employed to deposit the aluminum 92. A photoresist 93 is applied to the surface of the aluminum 92. As shown in FIG. 20, the photoresist 93 is exposed to ultraviolet rays. A photomask 94 is utilized to block the ultraviolet rays in a specific section. The photoresist 93 is partly exposed to the ultraviolet rays in this manner.

The unexposed section of the photoresist 93 is then removed as shown in FIG. 21. A predetermined developing solution is utilized for the removal. The exposed section of the photoresist 93 remains on the aluminum 92. The aluminum 92 is then subjected to application of an etching solution. A phosphoric acid solution is employed as the etching solution, for example. The aluminum 92 remains on the p-type semiconductor 91 as shown in FIG. 22. The aluminum 92 serves as an electrode. These diodes 75, 77 may be adhered to the aforementioned flying head slider 22.

The Si film 87 may be formed directly on the flying head slider 22. CVD (chemical vapor deposition) is employed to form the Si film 87. The CVD enables epitaxial growth of the Si film 87 on the flying head slider 22. Boron (B) may be implanted into the Si film 87 after the epitaxial growth. An ion-implantation technique may be employed for the implantation, for example. An electrode made of aluminum may be formed after the implantation in the same manner as described above. The first and second diodes 75, 77 are formed on the flying head slider 22 in this manner.

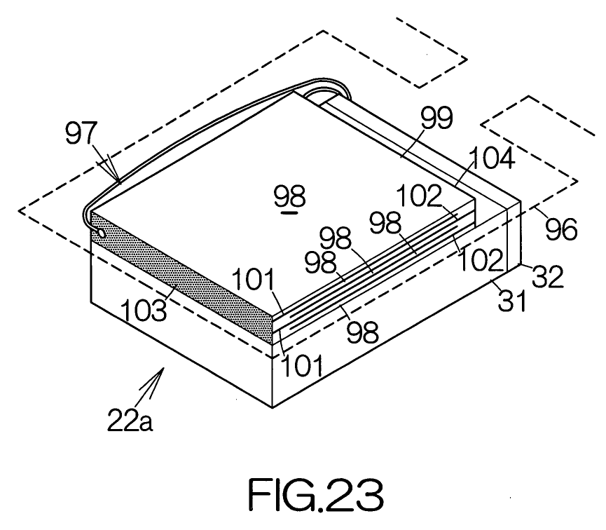

FIG. 23 illustrates a flying head slider 22a according to a second embodiment of the present invention. A piezoelectric actuator 97 is interposed between the slider body 31 and a flexure 96 in the flying head slider 22a. The piezoelectric actuator 97 serves as a second actuator. In this case, the heating wiring pattern 65 in combination with the Al₂O₃ film 51 or the heating wiring pattern 66 in combination with the non-magnetic layer 61 serves as a first actuator.

The piezoelectric actuator 97 includes a piezoelectric element 99. The piezoelectric element 99 includes a bulk of layered piezoelectric ceramic thin plates 98. The piezoelectric ceramic thin plates 98 are overlaid on one another in parallel with the surface of the slider body 31. The piezoelectric ceramic thin plates 98 may be made of a piezoelectric material such as PNN-PT-PZ.

First and second electrode layers 101, 102 are alternately interposed between the piezoelectric ceramic thin plates 98. A first lead layer 103 is attached to one of the opposite ends of the layered piezoelectric ceramic thin plates 98. All the first electrode layers 101 are connected to the first lead layer 103. A second lead layer 104 is likewise attached to the other of the opposite ends of the layered piezoelectric ceramic thin plates 98. All the second electrode layers 102 are connected to the second lead layer 104. The first and second electrode layers 101, 102 and the first and second lead layers 103, 104 may be made of an electrically-conductive metallic material such as Pt.

When a driving voltage is supplied to the first and second lead layers 103, 104, a potential difference is generated between the first and second electrode layers 101, 102. Polarization is induced in the individual piezoelectric ceramic thin plate 98. The direction of polarization depends on the direction of the voltage established between the first and second electrode layers 101, 102. The voltage is continuously applied in the direction of the polarization. This results in shrinkage of the piezoelectric element 99 in the longitudinal direction along the direction of the airflow. The slider body 31 is thus bent. The curvature of the bottom surface 34 is increased. The flying height of the flying head slider 22a can thus be increased.

Green sheets made of PNN-PT-PZ are utilized to produce the piezoelectric element 99. The first or second electrode layers 101, 102 are formed on the individual green sheet. Screen printing is employed form the first and second electrode layers 101, 102, for example. Pt may be selected as the electrically-conductive material for the first and second electrode layers 101, 102. The green sheets are overlaid on one another. The overlaid green sheets are then sintered in the atmosphere. The green sheets are subjected to a high temperature of approximately 1,050 degrees Celsius, for example. The first and second lead layers 103, 104 are thereafter formed. Alternatively, a printing process employing a PNN-PT-PZ paste and a Pt paste may be employed to form the piezoelectric actuator 97. In this case, the piezoelectric ceramic thin plates 98 and the first and second electrode layers 101, 102 are formed directly on the surface of the slider body 31.

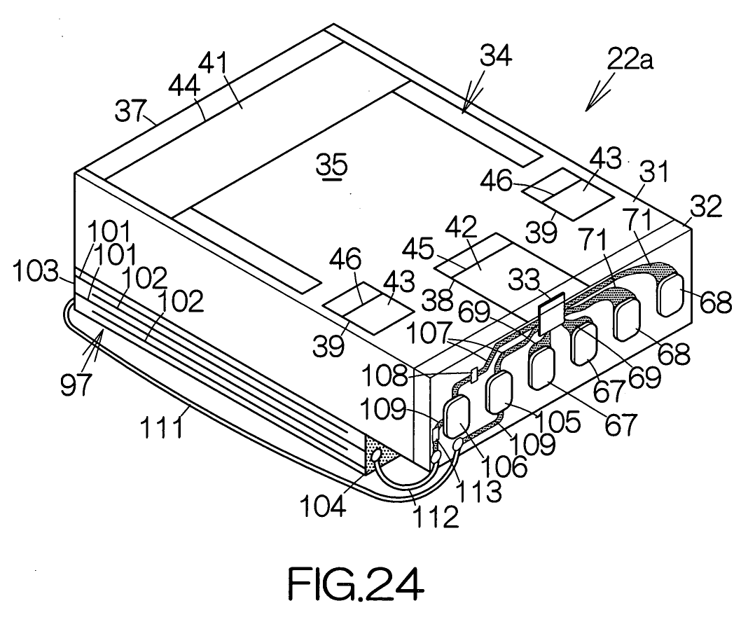

As shown in FIG. 24, first and second electrically-conductive terminals 105, 106 are located on the head protection film 32 in addition to the aforementioned electrically-conductive signal line terminals 67, 68. The first electrically-conductive terminal 105 is connected to the second electrically-conductive terminal 106 through a first wiring pattern 107. The heating wiring pattern 65 or 66 is defined in the first wiring pattern 107, for example. A capacitor 108 is inserted in the first wiring pattern 107. The capacitor 108 is connected in series to the heating wiring pattern 65 or 66. The second electrically-conductive terminal 106 is likewise connected to the first electrically-conductive terminal 105 through a second wiring pattern 109. The second wiring pattern 109 extends in parallel with the first wiring pattern 107. The aforementioned piezoelectric actuator 97 is inserted in the second wiring pattern 109. Bonding wires 111, 112 are utilized to connect the first and second lead layers 103, 104 to the second wiring pattern 109 on the head protection film 32. A resistance element 113 is inserted in the second wiring pattern 109. The resistance element 113 is connected in series to the piezoelectric actuator 97. The resistance element 113 is designed to exhibit a predetermined electric resistance. The first and second electrically-conductive terminals 105, 106 are exposed on the surface of the head protection film 32.

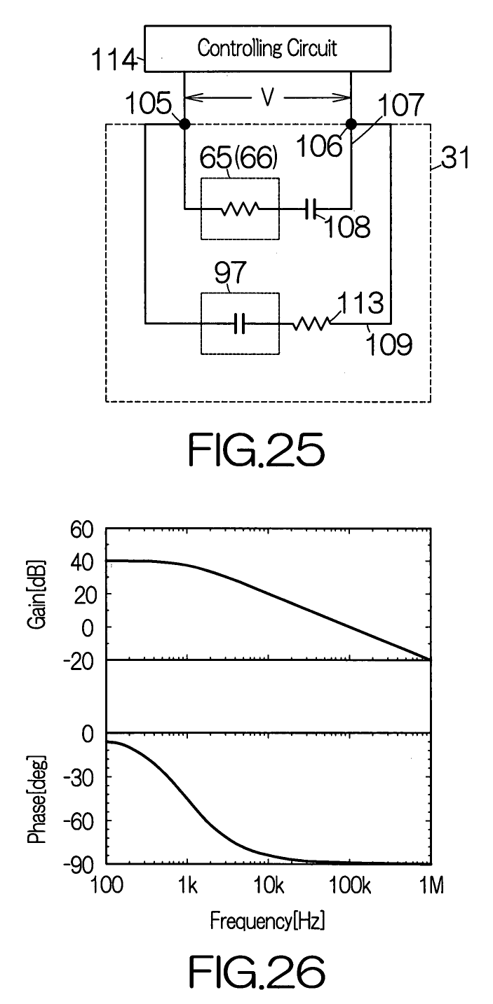

The first and second electrically-conductive terminals 105, 106 are connected to the wiring pattern, not shown, on the flexible printed wiring board 29. A connecting terminal such as a metallic ball made of Au is utilized to establish the connection, for example. As shown in FIG. 25, a controlling circuit 114 is connected to the first and second electrically-conductive terminals 105, 106. In this case, the wiring pattern on the flexible printed wiring board 29 in combination with the first wiring pattern 107 establishes a first wiring according to the present invention. Likewise, the bonding wires 111, 112 in combination with the second wiring pattern 109 establish a second wiring according to the present invention. The first and second electrically-conductive terminals 105, 106 respectively serve as first and second diverging points according to the present invention. The capacitance of the capacitor 108 in combination with the electric resistance of the heating wiring pattern 65 or 66 establishes a first filtering circuit. The electric resistance of the resistance element 113 in combination with the capacitance of the piezoelectric actuator 97 establishes a second filtering circuit. Like reference numerals are attached to the structure or components equivalent to those of the aforementioned first embodiment.

Now, assume that the alternating voltage is applied to the wiring pattern on the flexible printed wiring board 29 from the controlling circuit 114. The driving characteristic of the first actuator is specified by the following transfer function in the same manner as the above-described one:

$$\begin{matrix}\text{[Expression 2]} & \\ \frac{Z ( s )}{W ( s )} = \frac{α}{\frac{τ}{2 π} s + 1} & ( 1 )\end{matrix}$$

If the gain α is set at 100 [nm/W] and the time constant τ is set at 1.0 [ms], for example, the gain and phase characteristics of the first actuator are established, as shown in FIG. 26. In addition, the driving characteristic of the second actuator or piezoelectric actuator 97 is specified by the following transfer function:

$$\begin{matrix}\text{[Expression 3]} & \\ \frac{X ( s )}{V ( s )} = \frac{{βω}^{2}}{{s}^{2} + 2 ϛω s + {ω}^{2}} & ( 2 )\end{matrix}$$

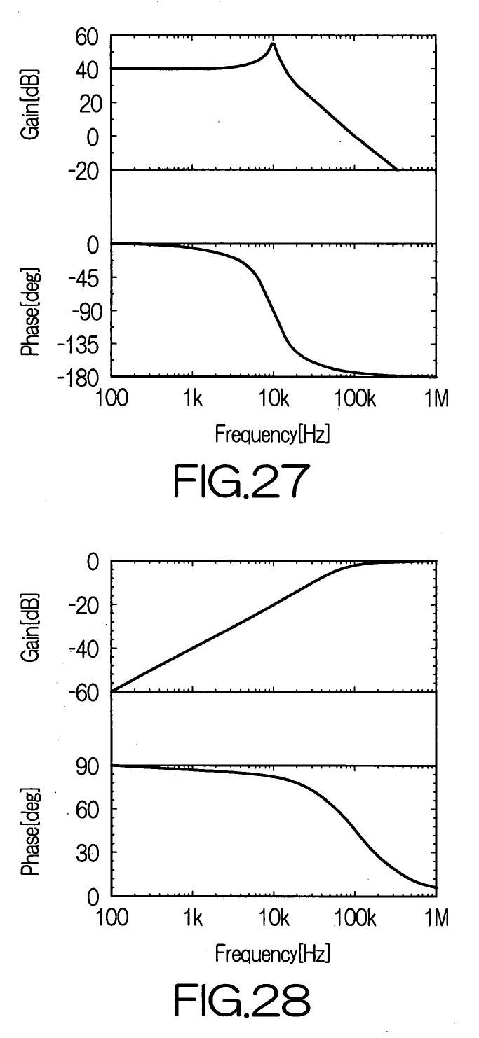

In this case, X denotes the movement amount [nm] of the piezoelectric actuator 97. V denotes voltage [V] applied to the piezoelectric actuator 97. β denotes the gain [nm/V]. ω denotes the resonance frequency [rad/s]. ζ denotes the damping ratio. If the gain ρ is set at 100 [nm/V], the resonance frequency ω is set at 6.28×10⁴ [rad/s](=10 kHz), and the damping ratio ζ is set at 0.1, for example, the gain and phase characteristics of the piezoelectric actuator 97 are established, as shown in FIG. 27.

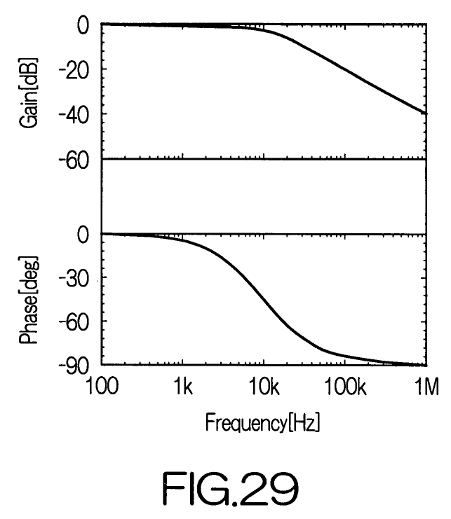

Here, assume that the electric resistance of the heating wiring pattern 65 or 66 is set at 100 [Ω], the capacitance of the capacitor 108 is set at 16 [nF], the electric resistance of the resistance element 113 is set at 16 [kΩ], and the capacitance of the piezoelectric actuator 97 is set at 1.0 [nF]. The gain and phase characteristics of the first filtering circuit are established as shown in FIG. 28, for example. This results in elimination of a frequency component equal to or below 100 [kHz] at the first filtering circuit. A so-called high-pass filter is established. The gain and phase characteristics of the second filtering circuit are likewise established as shown in FIG. 29. This results in elimination of a frequency component equal to or above 10 [kHz] at the second filtering circuit. A so-called low-pass filter is established.

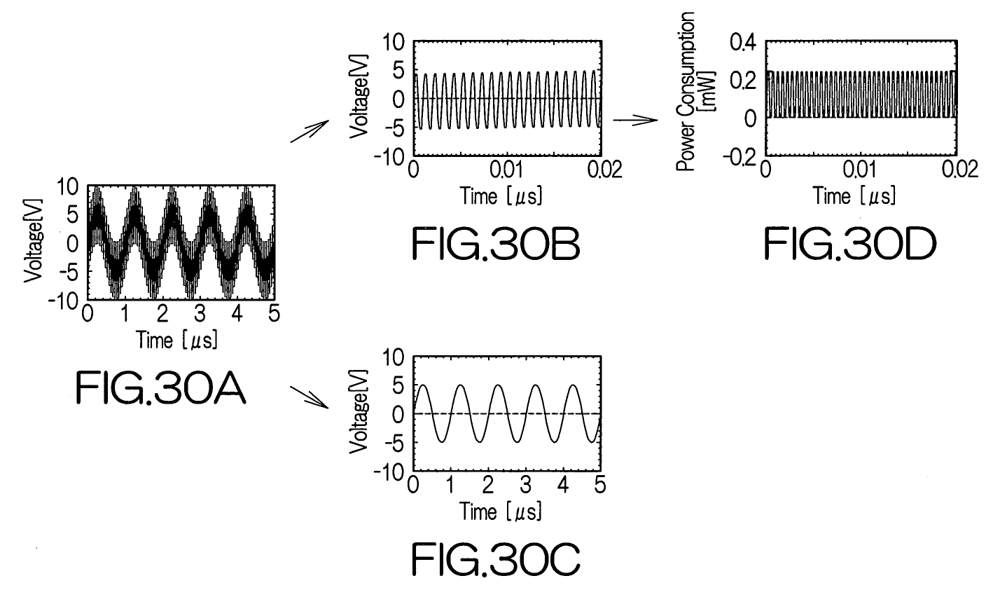

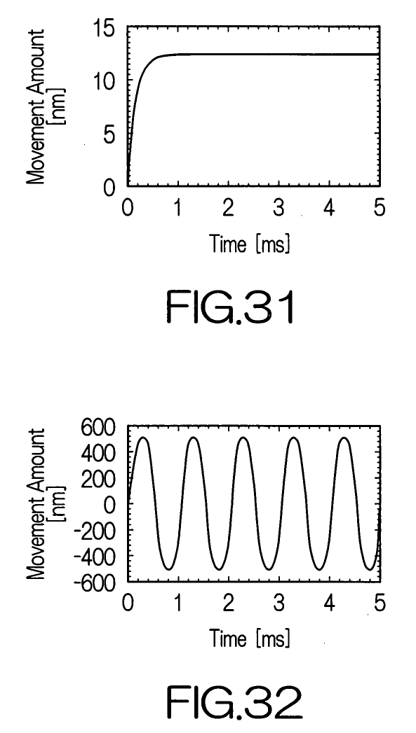

The superposed signal of a high-frequency signal and a low-frequency signal are utilized for the alternating voltage, as shown in FIG. 30A. The high-frequency signal is designed to have the frequency of 1.0 [MHz] and the amplitude of ±5 [V]. The low-frequency signal is designed to have the frequency of 1.0 [kHz] and the amplitude of ±5 [V]. In this case, the high-frequency signal passes through the first filtering circuit. The low-frequency signal is blocked at the first filtering circuit. Only the high-frequency signal is thus applied to the heating wiring patterns, as shown in FIG. 30B. The low-frequency signal passes through the second filtering circuit. The high-frequency signal is blocked at the second filtering circuit. Only the low-frequency signal is thus applied to the piezoelectric actuator 97, as shown in FIG. 30C. The high-frequency signal in this manner serves to control the first actuator. The low-frequency signal likewise serves to control the second actuator or piezoelectric actuator 97. If the electric resistance of the first actuator is set at 100 [Ω], the power consumption of the first actuator is specified, as shown in FIG. 30D. The movement amount of the first actuator is thus specified as shown in FIG. 31. The movement amount of the piezoelectric actuator 97 is specified based on a voltage level, as shown in FIG. 32, for example. While the read head element 47 and the write head element 48 protrude by predetermined amounts in the flying head slider 22a during the flight, the slider body 31 is bent. The first and second actuators are respectively controlled in this manner.

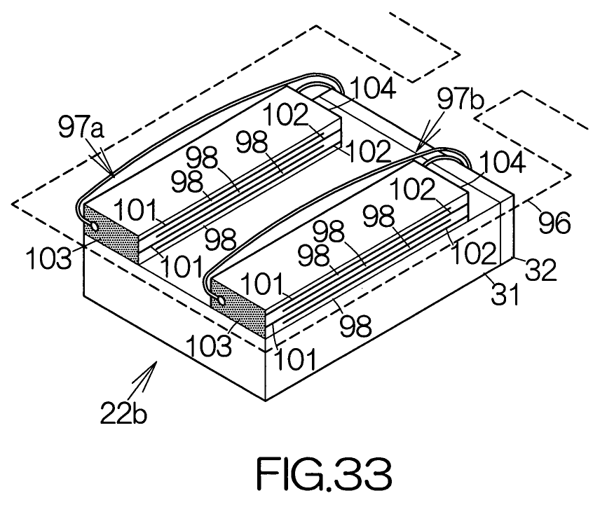

FIG. 33 illustrates a flying head slider 22b according to a third embodiment of the present invention. First and second piezoelectric actuators 97a, 97b are interposed between the slider body 31 and the flexure 96 in the flying head slider 22b. The first piezoelectric actuator 97a serves as a second actuator. The second piezoelectric actuator 97b serves as a third actuator. In this case, the heating wiring pattern 65 in combination with the Al₂O₃ film 51 or the heating wiring pattern 66 in combination with the non-magnetic layer 61 serves as a first actuator. Each of the first and second actuators 97a, 97b may have the structure similar to that of the aforementioned piezoelectric actuator 97.

The first piezoelectric actuator 97a shrinks in the longitudinal direction along the airflow in response to supply of a driving voltage to the first piezoelectric actuator 97a, for example. Likewise, the second piezoelectric actuator 97b shrinks in the longitudinal direction along the airflow in response to supply of a driving voltage to the second piezoelectric actuator 97b, for example. The slider body 31 is thus locally bent. This results in a local increase in the curvature of the bottom surface 34. The flying head slider 22a is allowed to enjoy the adjustment on not only the flying height of the flying head slider 22a but also the roll angle of the slider body 31.

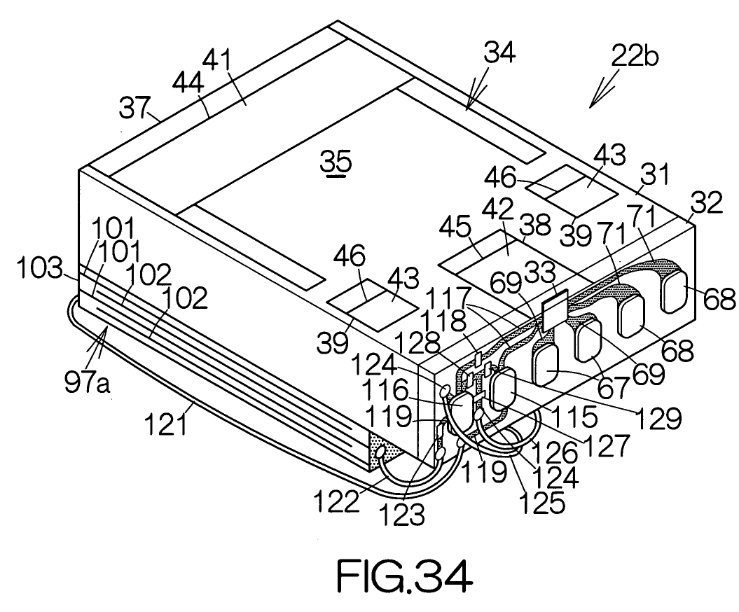

As shown in FIG. 34, first and second electrically-conductive terminals 115, 116 are located on the head protection film 32 in addition to the aforementioned electrically-conductive signal line terminals 67, 68. The first and second electrically-conductive terminals 115, 116 are exposed on the surface of the head protection film 32. The first electrically-conductive terminal 115 is connected to the second electrically-conductive terminal 116 through a first wiring pattern 117. The heating wiring pattern 65 or 66 is defined in the first wiring pattern 117. A capacitor 118 is inserted in the first wiring pattern 117. The capacitor 118 is connected in series to the heating wiring pattern 65 or 66.

The first electrically-conductive terminal 115 is likewise connected to the second electrically-conductive terminal 116 through a second wiring pattern 119. The second wiring pattern 119 extends in parallel with the first wiring pattern 117. The aforementioned first piezoelectric actuator 97a is inserted in the second wiring pattern 119. Bonding wires 121, 122 are utilized to connect the first and second lead layers 103, 104 to the second wiring pattern 119 on the head protection film 32. A first resistance element 123 is also inserted in the second wiring pattern 119. The first resistance element 123 is connected in series to the first piezoelectric actuator 97a. The first resistance element 123 is designed to exhibit a predetermined electric resistance.

The first electrically-conductive terminal 115 is connected to the second electrically-conductive terminal 116 through a third wiring pattern 124. The third wiring pattern 124 extends in parallel with the first and second wiring patterns 117, 119. The aforementioned second piezoelectric actuator 97b is inserted in the third wiring pattern 124. Bonding wires 125, 126 are utilized to connect the first and second lead layers 103, 104 to the third wiring pattern 124 on the head protection film 32. Second and third resistance elements 127, 128 are also inserted in the third wiring pattern 124. The second resistance element 127 is connected in series to the second piezoelectric actuator 97b. The third resistance element 128 is connected in parallel to the second piezoelectric actuator 97b and the second resistance element 127. Each of the second and third resistance elements 127, 128 is designed to exhibit a predetermined electric resistance. A capacitor 129 is also inserted in the third wiring pattern 124. The capacitor 129 is connected in series to the second piezoelectric actuator 97b and the second and third resistance elements 127, 128.

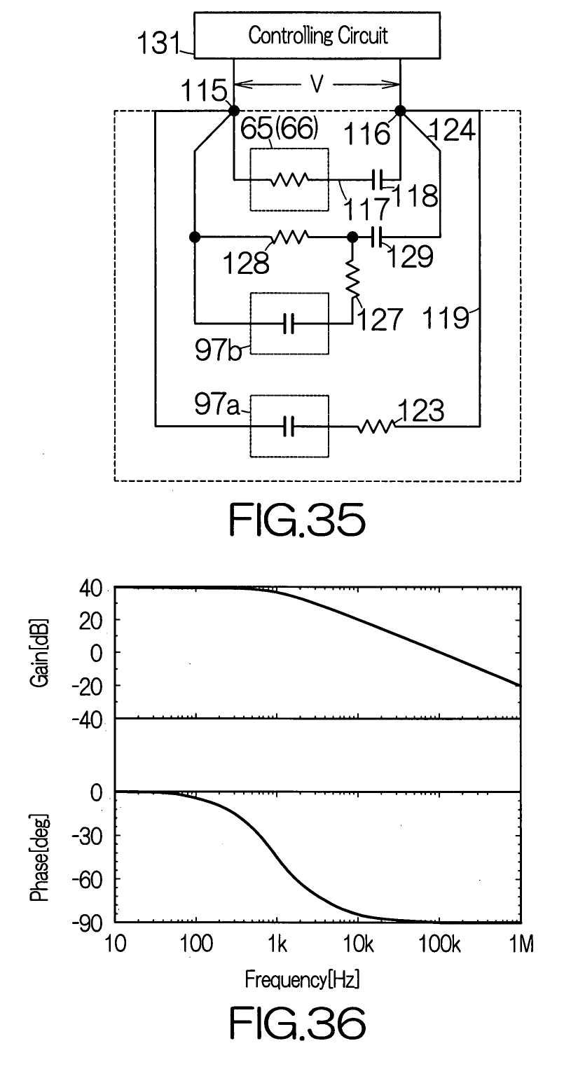

The first and second electrically-conductive terminals 115, 116 are connected to the wiring pattern on the flexible printed wiring board 29. A connecting terminal such as a metallic ball made of Au is utilized to establish the connection, for example. As shown in FIG. 35, a controlling circuit 131 is connected to the first and second electrically-conductive terminals 115, 116. In this case, the wiring pattern on the flexible printed wiring board 29 in combination with the first wiring pattern 117 establishes a first wiring according to the present invention. Likewise, the bonding wires 121, 122 in combination with the second wiring pattern 119 establish a second wiring according to the present invention. The bonding wires 125, 126 in combination with the third wiring pattern 124 establishes a third wiring according to the present invention. The first and second electrically-conductive terminals 115, 116 respectively serve as first and second diverging points according to the present invention. The capacitance of the capacitor 118 in combination with the electric resistance of the heating wiring pattern 65 or 66 establishes a first filtering circuit. The electric resistance of the first resistance element 123 in combination with the capacitance of the first piezoelectric actuator 97a establishes a second filtering circuit. The capacitor 129 in combination with the capacitance of the second piezoelectric actuator 97b and the electric resistance of the second and third resistance elements 127, 128 establishes a third filtering circuit. Like reference numerals are attached to the structure or components equivalent to those of the aforementioned first embodiment.

Now, assume that the alternating voltage is applied to the wiring pattern on the flexible printed wiring board 29 from the controlling circuit 131. The driving characteristic of the first actuator is specified by the following transfer function in the same manner as the above-described one:

$$\begin{matrix}\text{[Expression 4]} & \\ \frac{Z ( s )}{W ( s )} = \frac{α}{\frac{τ}{2 π} s + 1} & ( 1 )\end{matrix}$$

If the gain α is set at 100 [nm/W] and the time constant τ is set at 1.0 [ms], for example, the gain and phase characteristics of the first actuator are established as shown in FIG. 36. The driving characteristic of the second and third actuators or first and second piezoelectric actuators 97a, 97b is specified by the following transfer function in the same manner as the above-described one:

$$\begin{matrix}\text{[Expression 5]} & \\ \frac{X ( s )}{V ( s )} = \frac{{βω}^{2}}{{s}^{2} + 2 ϛω s + {ω}^{2}} & ( 2 )\end{matrix}$$

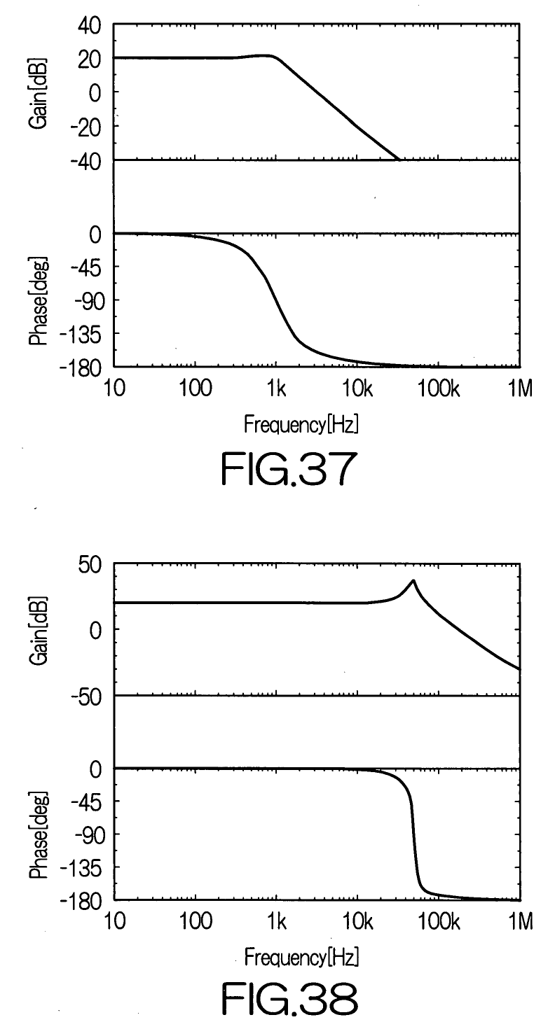

If the gain β is set at 10 [nm/V], the resonance frequency ω is set at 6.28×10⁴ [rad/s](=1.0 kHz), and the damping ratio ζ is set at 0.5, for example, the gain and phase characteristics of the first piezoelectric actuator 97a are established as shown in FIG. 37. If the gain β is set at 10 [nm/V], the resonance frequency ω is set at 3.14×10⁵ [rad/s](=50 kHz), and the damping ratio ζ is set at 0.1, for example, the gain and phase characteristics of the second piezoelectric actuator 97b are established, as shown in FIG. 38.

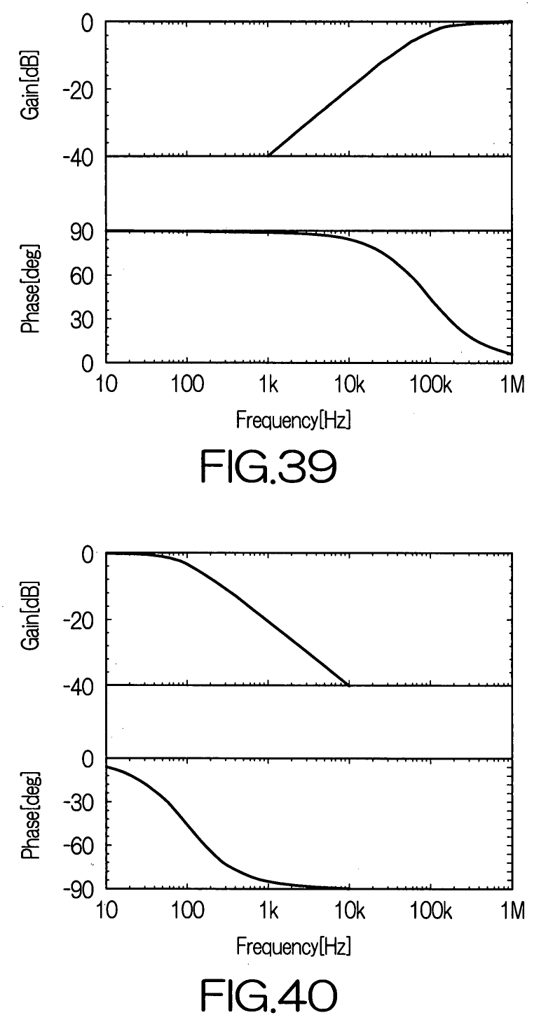

Here, assume that the electric resistance of the heating wiring pattern 65 or 66 is set at 100 [Ω], the capacitance of the capacitor 118 is set at 16 [nF], the capacitance of the first and second piezoelectric actuators 97a, 97b is respectively set at 10 [nF], 1.0 [nF], and the electric resistance of the first to third resistance elements 123, 127, 128 are respectively set at 160 [kΩ], 1.6 [kΩ], 160 [kΩ]. The gain and phase characteristics of the first filtering circuit are established as shown in FIG. 39, for example. This results in elimination of a frequency component equal to or below 100 [kHz] at the first filtering circuit. A so-called high-pass filter is established. The gain and phase characteristics of the second filtering circuit are also established as shown in FIG. 40. This results in elimination of a frequency component equal to or above 100 [Hz] at the second filtering circuit. A so-called low-pass filter is established. The gain and phase characteristics of the third filtering circuit are similarly established as shown in FIG. 41, for example. This results in elimination of frequency components equal to or below 1.0 [kHz] and equal to or above 100 [kHz] at the third filtering circuit. A so-called band-pass filter is established.

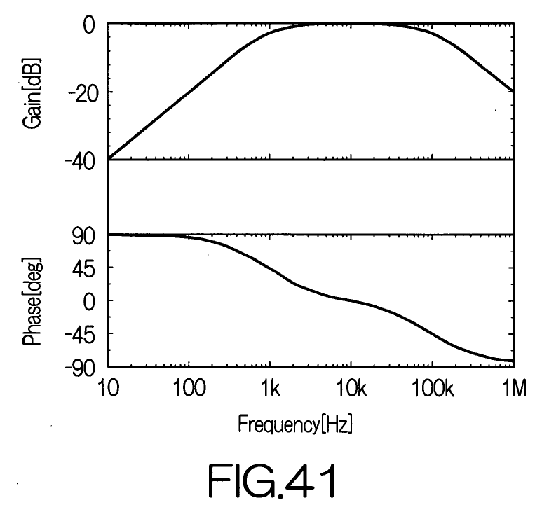

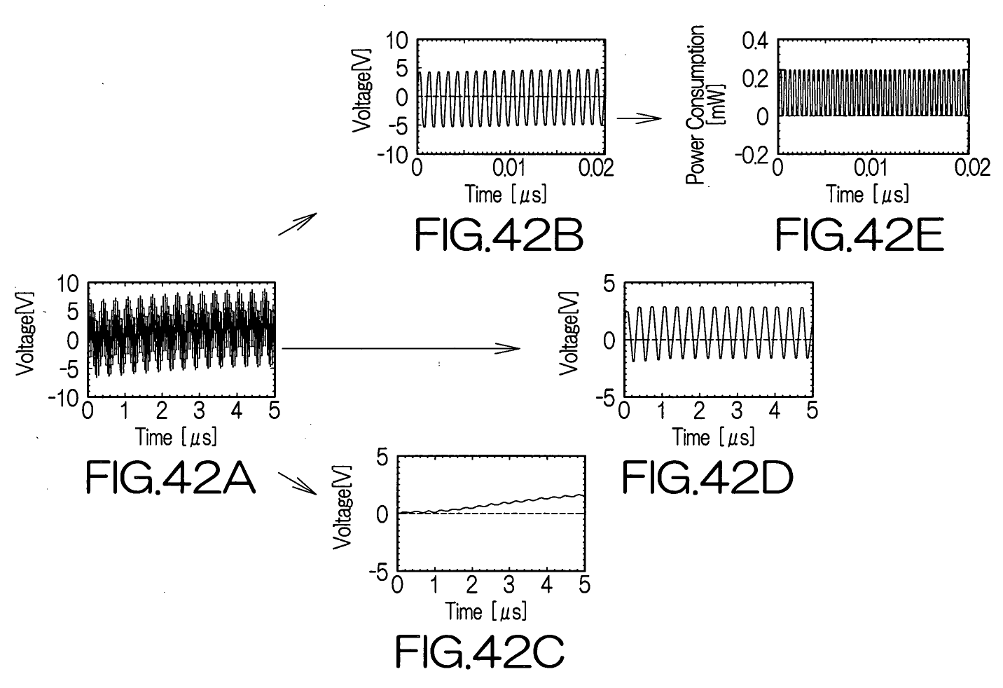

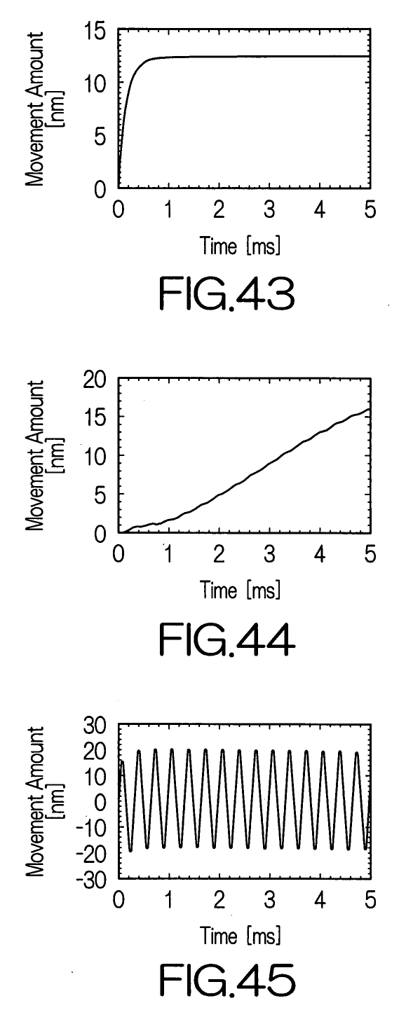

The superposed signal of a high-frequency signal, a low-frequency signal and an intermediate-frequency signal are utilized for the alternating voltage, as shown in FIG. 42A. The high-frequency signal is designed to have the frequency of 1 [MHz] and the amplitude of +5 [V]. The low-frequency signal is designed to have the frequency of 50 [Hz] and the amplitude of ±2 [V]. The intermediate-frequency signal is designed to have the frequency of 3 [kHz] and the amplitude of +2 [V]. In this case, the high-frequency signal passes through the first filtering circuit. The low-frequency and intermediate-frequency signals are blocked at the first filtering circuit. Only the high-frequency signals are thus applied to the heating wiring pattern 65 or 66, as shown in FIG. 42B. The low-frequency signal passes through the second filer circuit. The high-frequency and intermediate-frequency signals are blocked at the second filtering circuit. Only the low-frequency signals are thus applied to the first piezoelectric actuator 97a, as shown in FIG. 42C. The intermediate-frequency signal passes through the third filtering circuit. The high-frequency and low-frequency signals are blocked at the third filtering circuit. Only the intermediate-frequency signal is thus applied to the second piezoelectric actuator 97b, as shown in FIG. 42D. The high-frequency signal thus serves to control the first actuator. The low-frequency signal likewise serves to control the second actuator or first piezoelectric actuator 97a. The intermediate-frequency actuator also serves to control the third actuator or second piezoelectric actuator 97b. If the electric resistance of the first actuator is set at 10 [Ω], the power consumption of the first actuator is specified, as shown in FIG. 42E. The movement amount of the first actuator is thus specified as shown in FIG. 43. The movement amounts of the first and second piezoelectric actuators 97a, 97b are respectively specified based on a voltage level, as shown in FIGS. 44 and 45, for example. When the read head element 47 and the write head element 48 protrude by predetermined amounts in the flying head slider 22b during the flight, the slider body 31 is locally bent. The first to third actuators are respectively controlled in this manner.

A brief description will be made on a method of making the capacitors 108, 118. The capacitors 108, 118 can be formed directly on the slider body 31. An Al₂O₃ film 133 is previously formed on a substrate 132 made of Al₂O₃—TiC, as shown in FIG. 46, for example. An aluminum film 134 is formed on the surface of the Al₂O₃ film 133. High-frequency sputtering is employed to from the aluminum film 134, for example.

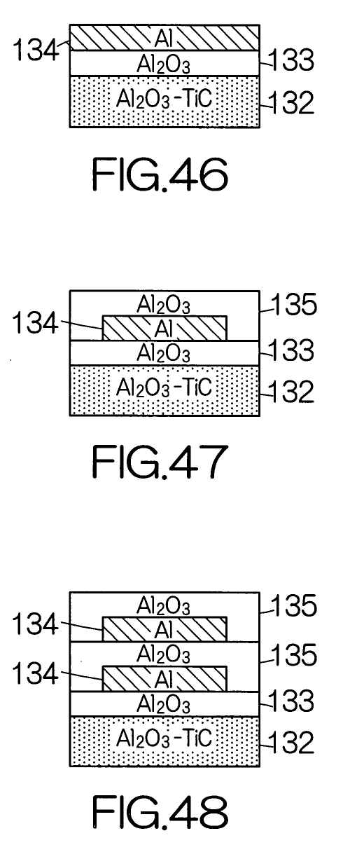

The aluminum film 134 is then trimmed in a predetermined shape as shown in FIG. 47. Photoresist may be utilized to trim the aluminum film 134 in the same manner as described above. An Al₂O₃ film 135 is thereafter formed on the surface of the aluminum film 134. Sputtering is employed to form the Al₂O₃ film 135, for example. The aluminum film 134 and the Al₂O₃ film 135 are repeatedly formed one after another, as shown in FIG. 48. The capacitors 108, 118 are in this manner established. The capacitance of the capacitors 108, 118 is proportional to the area of the aluminum films 134 and is inversely proportional to the distance between the aluminum films 134. Employment of the material having a high dielectric constant in place of Al₂O₃ leads to an increased capacitance of the capacitors 108, 118.

The filtering circuits utilized in the aforementioned embodiments can take any structure different from the described ones. Electric elements such as an electric resistance, a capacitor, a coil, and the like, may appropriately be employed in combination for establishment of the filtering circuits. In this case, the electric resistance value and the capacitance value of the individual electric element may be adjusted for determination of a passband.

The actuators in the aforementioned embodiments can take any structure different from the described ones. An electrostatic actuator or an electromagnetic actuator may be utilized. An electrostatic actuator is designed to serve as a capacitor in an electric circuit. The electromagnetic actuator is likewise designed to serve as a coil in an electric circuit.

The present invention may be applied to a so-called actuator for tracking control. The actuator enables the electromagnetic transducer 33 to move along the radial direction of the magnetic recording disk 14 at a minute amplitude, for example. The electromagnetic transducer 33 can keep following a target recording track on the magnetic recording disk 14 with a higher accuracy through such a minute movement. A contact head slider may be utilized in place of the aforementioned flying head slider 22.

What is claimed is:

1. A storage medium drive comprising:
a head slider;
a head element mounted on the head slider;
first and second actuators exhibiting a driving force to move the head element;
a controlling circuit designed to output an electric signal;
a first wiring connecting the first actuator to the controlling circuit;
a second wiring connected to the first wiring at first and second diverging points, the second wiring connecting the second actuator to the first wiring in parallel with the first actuator;
a first rectifying element inserted in the first wiring at a position between the first and second diverging points to rectify electric current in a first direction; and
a second rectifying element inserted in the second wiring to rectify electric current in a second direction opposite to the first direction.

2. The storage medium drive according to claim 1, further comprising:
a first electrically-conductive terminal inserted in the first wiring between the controlling circuit and the first diverging point, the first electrically-conductive terminal exposed on the head slider; and
a second electrically-conductive terminal inserted in the first wiring between the controlling circuit and the second diverging point, the second electrically-conductive terminal exposed on the head slider.

3. The storage medium drive according to claim 1, wherein the controlling circuit is designed to apply alternating voltage to the first wiring.

4. The storage medium drive according to claim 1, wherein each of the first and second actuators comprises:
a non-magnetic layer located at a position adjacent to the head element, the non-magnetic layer having a predetermined thermal expansion coefficient; and
a resistance element embedded in the non-magnetic layer for receiving electric current from the first or second wirings.

5. A head slider comprising:
a slider body;
a head element mounted on the slider body;
first and second actuators mounted on the slider body, the first and second actuators respectively exhibiting a driving force to move the head element;
first and second electrically-conductive terminals located on the slider body;
a first wiring connecting the first actuator to the first and second electrically-conductive terminals;
a first rectifying element inserted in the first wiring to rectify electric current, a rectified electrical current flowing from the first electrically-conductive terminal toward the second electrically-conductive terminal;
a second wiring connecting the second actuator to the first and second electrically-conductive terminals; and
a second rectifying element inserted in the second wiring to rectify electric current, a rectified electric current running from the second electrically-conductive terminal toward the first electrically-conductive terminal.

6. A storage medium drive comprising:
a head slider;
a head element mounted on the head slider;
first and second actuators exhibiting a driving force to move the head element;
a controlling circuit designed to output an electric signal;
a first wiring connecting the first actuator to the controlling circuit;
a second wiring connected to the first wiring at first and second diverging points, the second wiring connecting the second actuator to the first wiring in parallel with the first actuator;
a first filtering circuit established in the first wiring at a position between the first and second diverging points, the first filtering circuit allowing signals of a first frequency band to pass through; and
a second filtering circuit established in the second wiring, the second filtering circuit allowing signals of a second frequency band different from the first frequency band to pass through.

7. The storage medium drive according to claim 6, wherein the controlling circuit is designed to apply superposed signals including the signals of the first and second frequency bands to the first and second wirings.

8. The storage medium drive according to claim 6, wherein the first and second filtering circuits are established in combination with a resistance element and/or a capacitor and/or a coil.

9. The storage medium drive according to claim 6, further comprising a capacitor connected in series to the first actuator in the first wiring to establish the first filtering circuit in combination with electric resistance of the first actuator.

10. The storage medium drive according to claim 9, wherein the first actuator comprises:
a non-magnetic layer located at a position adjacent to the head element, the non-magnetic layer having a predetermined thermal expansion coefficient; and
a resistance element embedded in the non-magnetic layer for receiving electric current from the first wirings.

11. The storage medium drive according to claim 6, further comprising a resistance element connected in series to the second actuator in the second wiring to establish the second filtering circuit in combination with capacitance of the second actuator.

12. The storage medium drive according to claim 11, wherein the second actuator comprises a piezoelectric element including a piezoelectric material interposed between electrodes.

13. The storage medium drive according to claim 6, further comprising:
a third wiring connected to the first wiring at the first and second diverging point, the third wiring connecting a third actuator to the first wiring in parallel with the first and second actuators; and
a third filtering circuit established in the third wiring, the third filtering circuit allowing signals of a third frequency band different from the first and second frequency bands to pass through.

14. The storage medium drive according to claim 13, wherein the third filtering circuit is established in combination with a resistance element and/or a capacitor and/or a coil.

15. The storage medium drive according to claim 13, further comprising:
a first resistance element connected in series to the third actuator in the third wiring;
a second resistance element disposed in the third wiring in parallel with the third actuator and the first resistance element; and
a capacitor connected in series to the third actuator and the first and second resistance elements in the third wiring, the capacitor establishing the third filtering circuit in combination with capacitance of the third actuator and the electric resistance of the first and second resistance elements.

16. The storage medium drive according to claim 15, wherein the third actuator comprises a piezoelectric element including a piezoelectric material interposed between electrodes.

17. A head slider comprising:
a slider body;
a head element mounted on the slider body;
first and second actuators mounted on the slider body, the first and second actuators exhibiting a driving force to move the head element;
a pair of electrically-conductive terminals located on the slider body;
a first wiring connecting the first actuator to the electrically-conductive terminals;
a second wiring connected to the first wiring at first and second diverging points, the second wiring connecting the second actuator to the first wiring in parallel with the first actuator;
a first filtering circuit established in the first wiring between the first and second diverging points, the first filtering circuit allowing signals of a first frequency band to pass through; and
a second filtering circuit established in the second wiring, the second filtering circuit allowing signals of a second frequency band different from the first frequency band to pass through.
